(19) United States
(12) Patent Application Publication
(10) Pub. No.: US 2025/0035863 A1
(43) Pub. Date: Jan. 30, 2025

(54) FIBER OPTIC CONNECTORS WITH A RETENTION BODY AND METHODS OF FABRICATING THE SAME

(71) Applicant: CORNING RESEARCH & DEVELOPMENT CORPORATION, Corning, NY (US)

(72) Inventor: Joel Christopher Rosson, Hickory, NC (US)

(21) Appl. No.: 18/227,428

(22) Filed: Jul. 28, 2023

(51) Int. Cl. G02B 6/38; G02B 6/25

(52) U.S. Cl. CPC G02B 6/3887; G02B 6/25; G02B 6/3857

(57) ABSTRACT

In one embodiment, a fiber optic connector assembly includes a housing that includes a rear end and a front end with a longitudinal passageway extending therebetween. The rear end includes a flange. The fiber optic connector assembly also includes a retention body that includes a central portion, a front portion extending from the central portion in a first direction, and a rear portion extending from the central portion in a second direction. The central portion defines a front wall and rear wall, and the front portion of the retention body is disposed within the longitudinal passageway of the housing such that front wall and the flange define a primary groove. A boot is disposed over a portion of the rear portion of the retention body such that an insertion end of the boot and the rear wall of the retention body define a secondary groove.

### FIELD

The disclosure is directed to fiber optic connector assemblies and, more particularly, to fiber optic connector assemblies for mating with ports of a multi-port terminal.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G, and the like. As optical fiber extends deeper into communication networks there exists a need for building more complex and flexible fiber optic networks in a quick and easy manner.

Fiber optic connectors are often inserted into a receiving port, such as a port of a multi-port terminal. Preferably there should be a sealing element between the fiber optic connector and an inner wall of the port to prevent liquid, dust, and/or debris from the environment from entering the port and/or the fiber optic connector. However, molded plastic components of the fiber optic connector may require a parting line, which provides a leak risk. Further, insufficient sealing of the fiber optic connector and/or the port may cause damage to the fiber optic connector and/or the terminal.

Consequently, there exists an unresolved need for fiber optic connectors and ports having enhanced sealing capabilities.

### SUMMARY

Various embodiments of fiber optic connector assemblies are disclosed. The fiber optic connector assemblies of the present disclosure provide a connector sleeve as a component that is separate from a housing, which eliminates the need to have a molded parting line in a groove that receives a sealing member, which eliminates a leak risk at the groove. Embodiments also employ a secondary sealing element that is tapered and provides lead-in compressing during insertion of the fiber optic connector assembly into a port or a dust cap, which is not possible with a simple O-ring design. The two-part design of the connector housing and the connector sleeve also eliminate the parting line on the groove for the secondary seal, which further minimizes leak risk.

In one embodiment, a fiber optic connector assembly includes a housing that includes a rear end and a front end with a longitudinal passageway extending from the rear end to the front end, where the rear end includes a flange. The fiber optic connector assembly also includes a retention body that includes a central portion, a front portion extending from the central portion in a first direction, and a rear portion extending from the central portion in a second direction, where a diameter of the central portion is greater than a diameter of the front portion and the rear portion such that the central portion defines a front wall and rear wall, and the front portion of the retention body is disposed within the longitudinal passageway of the housing such that front wall and the flange define a primary groove, and a boot having an insertion end, where the boot is disposed over a portion of the rear portion of the retention body such that the insertion end of the boot and the rear wall of the retention body define a secondary groove.

In another embodiment, a fiber optic connector assembly includes a housing that includes a rear end and a front end with a longitudinal passageway extending from the rear end to the front end, where the rear end includes a flange. The fiber optic connector assembly also includes a retention body that includes a first end, a reduced diameter portion at the first end, a rear wall, and a second end extending from the rear wall, where a diameter of the central portion is greater than a diameter of the front portion and the rear portion such that the central portion defines a front wall and rear wall, and the front portion of the retention body is disposed within the longitudinal passageway of the housing such that front wall and the flange define a primary groove, and the second end of the retention body includes an engagement groove. The fiber optic connector assembly also includes a boot having an insertion end and a barb at an interior surface of the insertion end, where the boot is disposed over a portion of the rear end of the retention body such that the insertion end of the boot and the rear wall of the retention body define a secondary groove and the barb is disposed within the engagement groove.

In another embodiment, a method of assembling a fiber optic connector assembly includes removing a portion of a jacket of an optical cable to expose one or more strength members and an optical fiber. The method also includes cutting the one or more strength members. The method also includes inserting the optical cable into a retention body. The method also includes wrapping the one or more strength members around a front portion of the retention body in a direction toward a rear portion of the retention body such that the one or more strength members are disposed within a strength member enclosure of the cable adapter, and the optical fiber extends through an opening of a front end of the cable adapter. The method also includes crimping a crimp band on a crimp region of the front portion of the retention body such that the one or more strength members are positioned between the crimp region of the retention body and the crimp band. The method also includes inserting the front portion of the retention body into a longitudinal passageway of a housing such that the front portion is disposed within a rear end of the housing and an end of the optical fiber is positioned within a ferrule assembly disposed within a front end of the housing, where the retention body and the flange define a primary groove, the housing includes a flange at the rear end and an adhesive aperture, the front end of the retention body further includes an annular wicking region and an annular adhesive reservoir, and the adhesive aperture of the housing is aligned with the annular adhesive reservoir of the retention body. The method also includes disposing an adhesive within the adhesive aperture, the annular adhesive reservoir and the annular wicking region. The method also includes applying a curing energy to at least one of the retention body and the housing to cure the adhesive. The method also includes securing an insertion end of a boot to a portion of the second end of the connector sleeve, where the optical cable is disposed through the boot, and the boot and the retention body define a secondary groove.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 is a perspective assembled view of an example fiber optic connector assembly according to one or more embodiments described and illustrated herein;

FIG. 2 is a perspective exploded view of the example fiber optic connector assembly of FIG. 1 according to one or more embodiments described and illustrated herein;

FIG. 3 is a cross-sectional view of the example fiber optic connector assembly of FIGS. 1 and 2 according to one or more embodiments described and illustrated herein;

FIG. 4 is a perspective view of an example retention body according to one or more embodiments described and illustrated herein;

FIG. 5 is a perspective cutaway view of the example retention body of FIG. 4 and an optical cable according to one or more embodiments described and illustrated herein;

FIG. 6 is a cross-sectional view of an engagement between a retention body and a housing with an example fiber optic cable inserted therein according to one or more embodiments described and illustrated herein;

FIG. 7 is a perspective view of an example multiport terminal according to one or more embodiments described and illustrated herein;

FIG. 8 is a flowchart illustrating an example method of assembling a fiber optic connector assembly according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

The concepts disclosed are related to fiber optic connector assemblies and methods of their fabrication. The fiber optic connector assemblies of the present disclosure provide a retention body as a component that is separate from a housing, which eliminates the need to have a molded parting line in a groove that receives a sealing member, which eliminates a leak risk at the groove. Embodiments also employ a secondary sealing element that is tapered and provides lead-in compressing during insertion of the fiber optic connector assembly into a port or a dust cap, which is not possible with a simple O-ring design. The two-part design of the connector housing and the retention body also eliminate the parting line on the groove for the secondary seal, which further minimizes leak risk.

Various embodiments of fiber optic connector assemblies and methods of their fabrication are described in detail below.

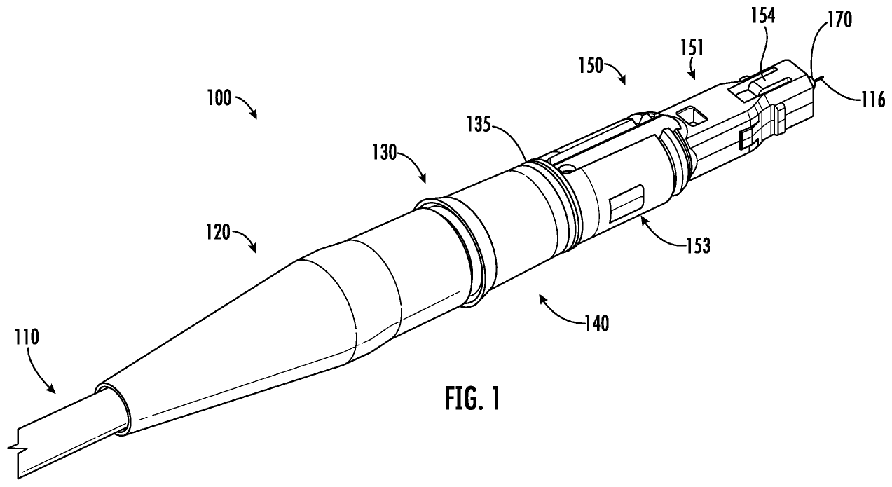

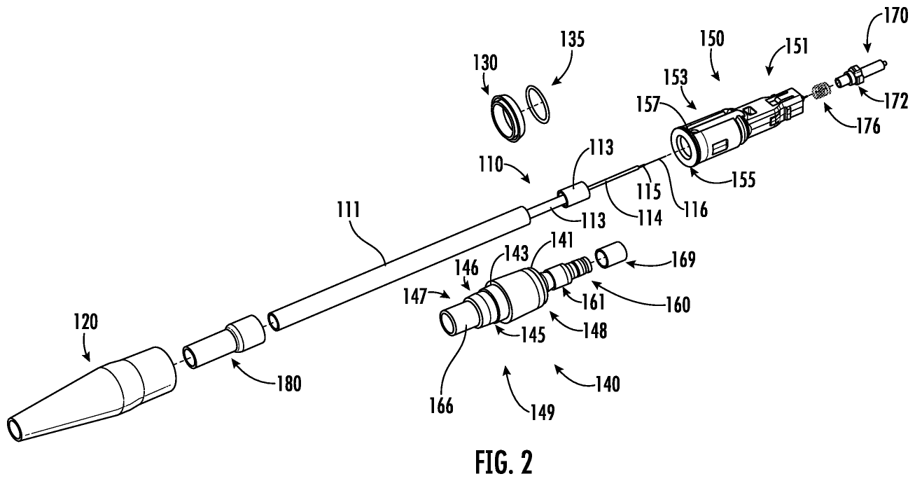

Referring now to FIGS. 1 and 2, a non-limiting, example fiber optic connector assembly 100 is illustrated. FIG. 1 is a perspective assembled view and FIG. 2 is a perspective exploded view of the fiber optic connector assembly 100. In the illustrated example, the fiber optic connector assembly 100 is configured as a Pushlok™ connector operable to be mated with ports of an Evolv™ terminal sold by Corning Optical Communications of Charlotte, NC. However, it should be understood that the embodiments described herein are not limited to the type of optical connector illustrated by FIG. 1.

The example fiber optic connector assembly 100 further includes a housing 150, a retention body 140 coupled to a rear end 153 of the housing 150, and a boot 120 coupled to a rear portion 149 of the retention body 140. As described in more detail below, a secondary sealing member 130 is positioned between the boot 120 and the retention body 140, and a primary sealing member 135 is positioned between the retention body 140 and the housing 150.

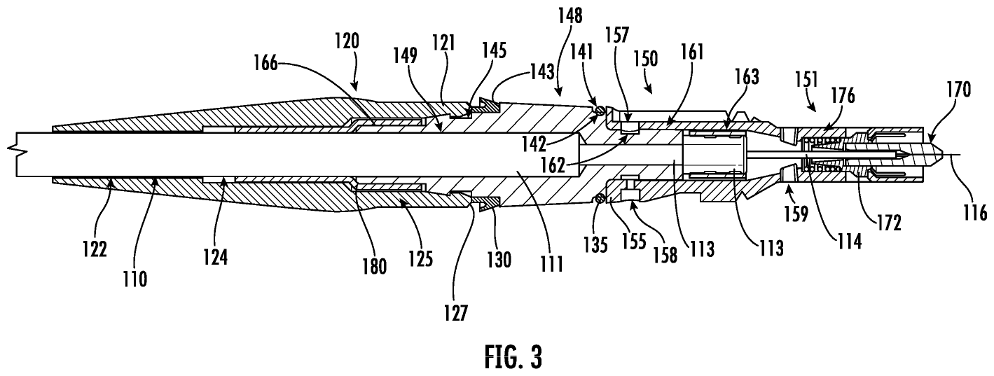

FIG. 3 is a cross-sectional view of the example connector assembly 100 depicted by FIGS. 1 and 2. Referring to FIGS. 1-3, the housing 150 generally includes an outer surface that extends around a perimeter of the housing 150. The outer surface may include one or more cross-sectional shapes. For example, in the embodiment depicted in FIGS. 1-3, the front end 151 of the housing 150 includes a rectangular cross-section including planar sides, while the rear end 153 of the housing 150 includes a curved outer surface having a flange 155. The rear end 153 may be cylindrical, for example.

The outer surface may also include one or more keying features and/or one or more locking features for engaging with components of a port of a terminal, as well as external threads for engagement with components, such as adapters, dust caps, and the like. The illustrated example includes a groove 154 that provides a keying feature for orienting the fiber optic connector assembly 100 in the proper orientation with respect to the port of the terminal.

The housing 150 includes a longitudinal passageway that extends from an opening at the front end 151 to an opening at the rear end 153. The longitudinal passageway is configured to receive and maintain a ferrule holder 172 that further maintains a cylindrical ferrule 170 in which a bare optical fiber 116 is disposed. A bias member 176 configured as a ferrule spring is also disposed within the longitudinal passageway to bias the ferrule holder 172 in a longitudinal direction toward the opening at the front end.

The rear end 153 of the housing 150 further includes an adhesive aperture 157 for receiving an adhesive (e.g., epoxy) to secure components maintained within the housing 150 as described in more detail below.

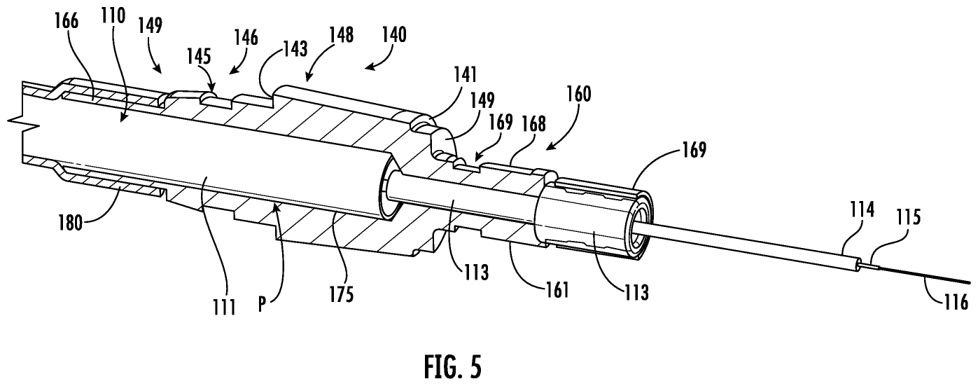

As shown in FIGS. 3 and 5, the rear end 153 of the housing 150 also includes a secondary aperture 158 that is provided so that adhesive may flow into the adhesive aperture 157, through the longitudinal passageway, and out of the secondary aperture 158.

Referring once again to FIG. 2, the retention body 140 is a component that is wholly separate from the housing 150. As described in more detail below, the retention body 140 is configured to provide regions for accepting sealing members for environmental protection when the fiber optic connector assembly 100 is mated with a port of a terminal. The retention body 140 has an outer surface that provides for several cylindrically shaped regions. However, in some embodiments the retention body 140 may have a shape that is elliptical in cross section, and/or have one or more portions having straight, non-curved surfaces.

The retention body 140 may be fabricated from a metal material and provide several advantages. For instance, using a metal material enhances the curing process of adhesive material or epoxy such as when using application of RF energy. Further, using a metal material for the retention body 140 may provide improved strength such as improved hoop strength for crimping a crimp band to it as described in more detail below. As a non-limiting example, the retention body 140 may be fabricated from aluminum. Further, the housing 150 may be formed from a polymer or not as desired.

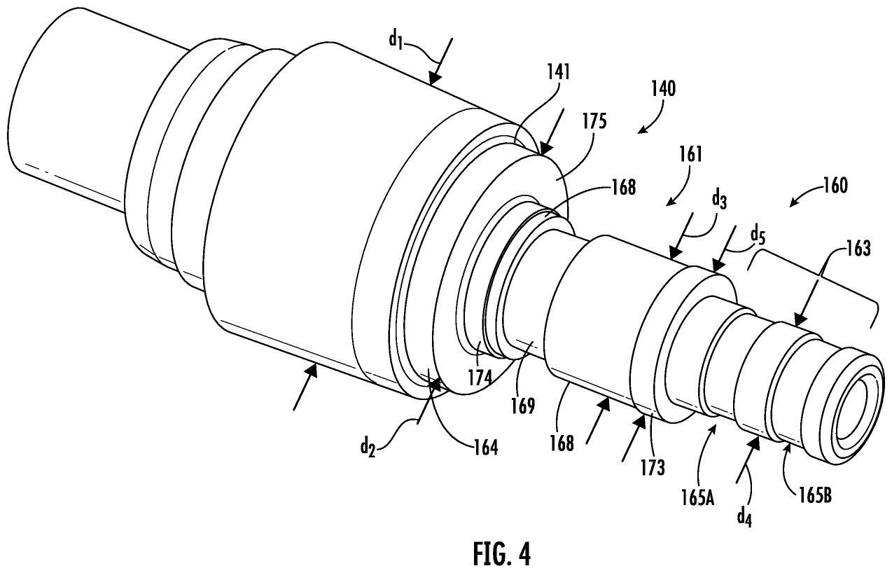

FIG. 4 illustrates the retention body 140 in isolation. As shown in FIGS. 2 and 4, the retention body 140 has a central portion 148, a front portion 160 extending from the central portion 148 in a first direction, and a rear portion 149 extending from the central portion 148 in a second direction that is opposite from the first direction on a longitudinal axis of the optical connector 100. The diameter d₁ of the central portion 148 is greater than the diameters of the front portion 160 such that the central portion 148 defines a front wall 141. The front portion 160 comprises a groove region 164 proximate the front wall 141 having a diameter d₂, an adhesive region 161 extending from the groove region 164 having a diameter d₃, and a crimp region 163 extending from the adhesive region 161 having a diameter d₄ such that d₄<d₃<d₂<d₁.

The adhesive region 161 includes an annular wicking region 168 that is provided on either side of an annular adhesive reservoir 162. As described in more detail below, the annular adhesive reservoir 162 is configured as an annular groove having a shallow annular relief to form a region for adhesive to wick into the annular wicking region 168 to increase adhesive coverage between the retention body 140 and the housing 150.

The crimp region 163 extends from the adhesive region 161, and has one or more annular crimping grooves 165A, 165B to enhance the crimping surface area when receiving the crimp band 169 by way of a crimped attachment. It should be understood that any number of crimping grooves may be provided, and/or different features may be provided to enhance the crimping connection (e.g., a knurl pattern feature).

The diameters of the rear portion 149 of the retention body 140 is less than the diameter of the central portion 148 thereby defining a rear wall 143 facing outward from the central portion 148 in a same direction as the rear portion 149. The rear portion 149 further includes an engagement groove 145 for engaging with the boot 120 and an end region 166 for receiving a heat shrink member.

FIG. 5 illustrates a cutaway view of the retention body 140 with an optical cable 110 disposed within a longitudinal passageway P therethrough. The optical cable 110 includes an outer jacket 111 that is cut such that it terminates within a jacket region 175 of the longitudinal passageway P. The optical cable 110 further includes one or more strength members 113 that are disposed within the outer jacket 111 and are cut to the desired length so that they may be secured to the retention body 140. The one or more strength members 113 may be any material that provide strength to the optical cable 110 such as, without limitation, Kevlar, aramid yarn, and glass-reinforced plastic threads. The one or more strength members 113 are cut and then wrapped around the crimp region 163 as shown in FIGS. 3 and 5. The one or more strength members 113 are secured to the crimp region 163 by crimping a crimp band 169 around the crimp region 163 with a crimping tool, for example, such that the one or more strength members 113 are positioned between the exterior surface of the crimp region 163 and the crimp band 169. The annular crimping grooves 165A, 165B provide additional surface area and features to enhance the securing of the one or more strength members 113 to the crimp region 163.

Still referring to FIG. 5, a heat shrink member 180 is applied to the end region 166 of the retention body 140 and the outer jacket 111 of the optical cable 110. The heat shrink member 180 provides environmental sealing for the rear portion 149 of the retention body 140.

Referring once again to the cross-sectional view of FIG. 3, the boot 120 is secured over the heat shrink member 180 and a portion of the retention body 140. The boot 120 includes a passageway comprising a jacket portion 122, a heat shrink portion 124 that is larger than the jacket portion 122 to accommodate the heat shrink member 180, and a retention body portion 125 that is larger than the jacket portion 122 to accommodate the end region 166 of the retention body 140 and heat shrink member 180. The boot 120 further includes an interior barb 121 at the end of the retention body portion 125. As shown by FIG. 3, the boot 120 is inserted over the end region 166 of the retention body 140 such that the barb 121 is disposed within the engagement groove 145 of the retention body 140. The placement of the barb 121 in the engagement groove 145 secures the boot 120 to the retention body 140.

An insertion end 127 of the boot 120 abuts a wall of the engagement groove 145, leaving a gap between the insertion end 127 and the rear wall 143 of the retention body 140 that defines a secondary groove 144 for receiving the secondary sealing member 130. The example secondary sealing member 130 has a straight portion 132 and a tapered portion 131 extending from an end of the straight portion 132. The tapered portion 131 is configured to be compressed against an inner surface of a port of a terminal.

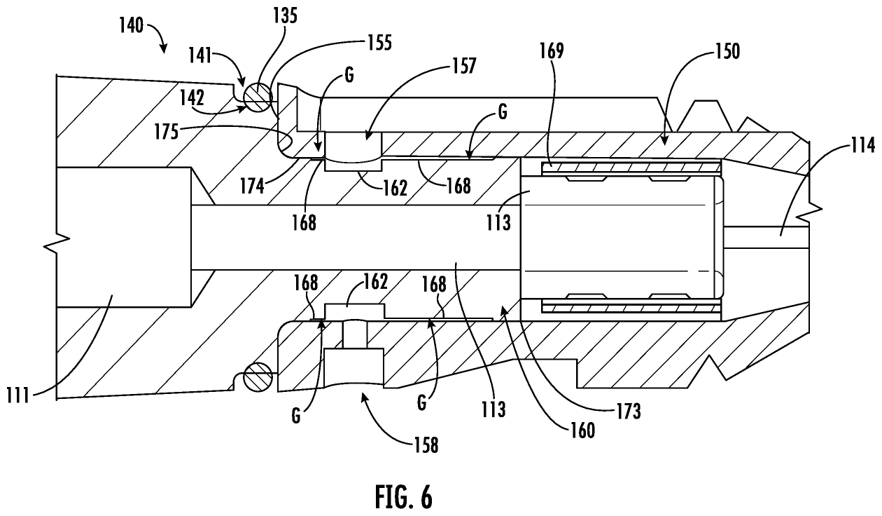

FIG. 6 is a close-up, cross-sectional view of the engagement between the front portion 160 of the retention body 140 and the connector housing 150. After the crimp band 169 is provided around the crimp region 163 and the one or more strength members 113 are secured to the retention body, the front portion 160 of the retention body 140 is inserted into the longitudinal passageway of the connector housing 150. The annular adhesive reservoir 162 is aligned with the adhesive aperture 157 and the secondary aperture 158. The diameter of the annular wicking region 168 is slightly smaller than the diameter of the interior passageway of the connector housing 150 to provide a gap G, which allows adhesive to wick between the annular wicking region 168 and the connector housing 150. The retention body 140 further includes first and second annular adhesive stopping regions 173, 174 having a diameter matching or closely matching the diameter of the longitudinal passageway of the connector housing 150 such that an interference fit is provided between the first and second annular adhesive stopping regions 173, 174 and the inner surface of the longitudinal passageway of the connector housing 150. The first and second annular adhesive stopping regions 173, 174 prevent forward and backward flow of the adhesive, thereby keeping the adhesive within the gap G.

When adhesive is provided to the adhesive aperture 157 and the retention body 140 is disposed about the rear end 153 of the housing 150, the adhesive flows into the annular adhesive reservoir 162 and then into the gap G formed by the annular wicking region 168 by capillary force. The adhesive also flows through the secondary aperture 158 in the rear end 153 of the housing 150. If desired, additional adhesive may be provided into the secondary aperture 158.

After the adhesive is applied and a portion of the retention body 140 is disposed in the housing 150, the adhesive may be cured by the application of RF energy in an RF curing process. The RF energy is converted into heat by the metal retention body, which accelerates the heat application and minimizes cure time. In this manner, the retention body 140 is secured to the connector housing 150. It should be understood that the retention body 140 may be fabricated from materials other than metal, such as molded plastic. In such embodiments, the adhesive may be cured by the application of heat through means other than RF curing (e.g., in an oven or with a heat gun).

After adhesive is provided through the adhesive aperture 157 of the housing 150, the front portion 160 of the retention body 140 is disposed within the rear end 153 of the housing 150, as shown in FIGS. 1 and 3. The flange 155 of the connector housing 150 abuts a wall 175 defined by the transition between the groove region 164 and the adhesive region 161, which provides a gap between the front wall 141 of the retention body 140 and the flange 155 of the connector housing 150. This gap, along with the groove region 164 of the retention body 140, defines a primary groove 142 for receiving a primary sealing member 135, which may be configured as an O-ring. The floor of the primary groove has no parting line.

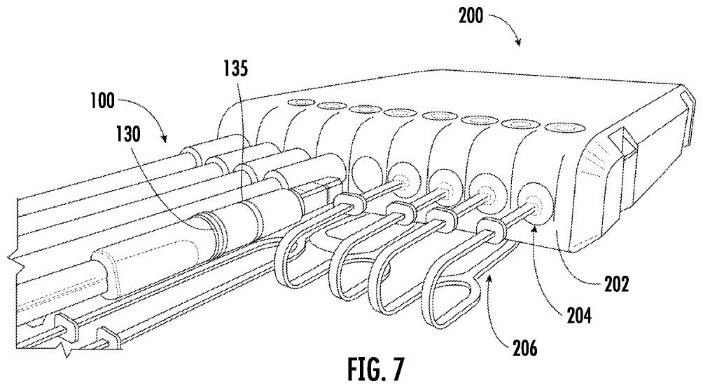

Referring now to FIG. 7, a non-limiting example fiber optic multiport assembly 200 is illustrated. The fiber optic multiport assembly 200 includes a multiport terminal 202, a plurality of fiber optic connector assemblies 100, and a plurality of dustplug assemblies 206. The multiport terminal 202 is configured to enable fiber-to-the-infrastructure (FTTx) for optical communication networks. As a non-limiting example, the multiport terminal 102 may be an Evolv™ terminal manufactured and sold by Corning Optical Communications of Charlotte, NC.

The multiport terminal 102 has a multiport body 202 that includes a plurality of ports 204 operable to receive a plurality of fiber optic connector assemblies 100, such as fiber optic connector of drop cables, for example.

In some instances, not all of the ports 204 of the multiport terminal 202 may be in use. For example, there may be more ports 204 than subscribers. To protect the internal components of the multiport terminal 200, dustplug assemblies 206 are inserted in unused ports 204. These dustplug assemblies 206 seal the unused ports 204 and protect the enclosure of the multiport terminal 202 from the environment.

When the fiber optic cable assembly 100 is inserted into port 204, the tapered portion 131 of the secondary sealing member 130 provides a lead-in surface that compresses against an inner surface of the port 204 (or a dust cap placed on the connector). As shown in FIG. 11, a gap 137 between tapered portion 131 and the straight portion 132 enables further compression of the tapered portion 131 toward the straight portion 132.

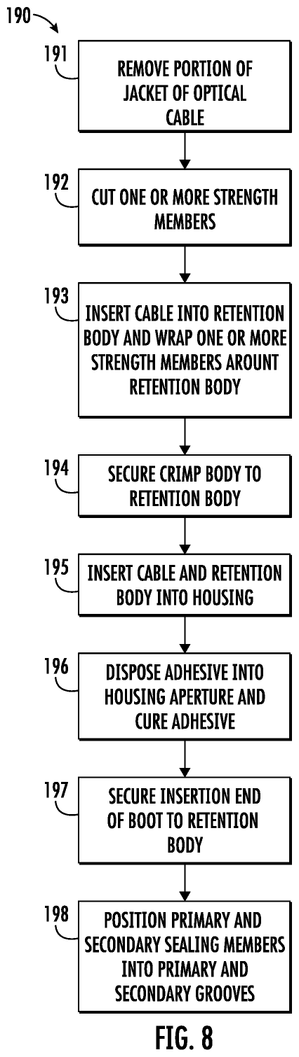

Referring now to FIG. 8, a flowchart 190 illustrating a method of fabricating a fiber optic connector assembly is provided. At block 191, a portion of the outer jacket of an optical cable is stripped away. Any method of stripping the outer jacket may be used. Stripping the outer jacket reveals one or more strength members and the optical fiber, which may be encased by one or more jacket and/or coating layers. The one or more jacket and/or coating layers may also be stripped at an end of the optical fiber.

At block 192, the one or more strength members are trimmed such that the optical fiber extends beyond the one or more strength members. At block 193, the optical cable is inserted into a retention body and the one or more strength members are wrapped around a crimping region of the retention body. It should be understood that the steps of blocks 192 and 193 may be performed in any order. Next, a crimp body is secured by the crimping region at block 194, such as by a crimping tool.

Next, the optical cable and the retention body are inserted into a longitudinal passageway of a housing at block 195 such that the cable adapter is disposed within a rear end of the housing and an end of the optical fiber is positioned within a ferrule assembly disposed within a front end of the housing. As described above, the housing comprises a housing adhesive aperture at the rear end.

To secure the retention body to the housing, at block 196 an adhesive is disposed within the housing adhesive aperture to flow adhesive into an adhesive reservoir and adhesive wicking region. The adhesive is then cured, such as by application of UV light, RF energy, and/or the like. A heat shrink member may also be applied to the end region of the retention body and the outer jacket of the optical cable. Heat is then applied to the heat shrink member to shrink it around the retention body and the outer jacket of the optical cable.

Next, an insertion end of a boot is secured to a portion of the second end of the retention body at block 197 such that the optical cable is disposed through the boot, and the rear wall of the retention body and the insertion end of the boot define a secondary groove. At block 198, primary and secondary sealing members are positioned in the primary and secondary grooves, respectively.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A fiber optic connector assembly comprising:
a housing comprising a rear end and a front end with a longitudinal passageway extending from the rear end to the front end, wherein the rear end comprises a flange;
a retention body comprising a central portion, a front portion extending from the central portion in a first direction, and a rear portion extending from the central portion in a second direction, wherein:
a diameter of the central portion is greater than a diameter of the front portion and the rear portion such that the central portion defines a front wall and rear wall, and
the front portion of the retention body is disposed within the longitudinal passageway of the housing such that front wall and the flange define a primary groove, and
a boot having an insertion end, wherein the boot is disposed over a portion of the rear portion of the retention body such that the insertion end of the boot and the rear wall of the retention body define a secondary groove.

2. The fiber optic connector assembly of claim 1, wherein the retention body is fabricated from a metal.

3. The fiber optic connector assembly of claim 1, further comprising a ferrule assembly comprising a ferrule holder, a ferrule disposed in the ferrule holder, wherein the ferrule assembly is disposed within the longitudinal passageway at the front end of the housing.

4. The fiber optic connector assembly of claim 1, the connector assembly further comprising an optical cable comprising a jacket, one or more strength members within the jacket, and an optical fiber within the jacket.

5. The fiber optic connector assembly of claim 4, further comprising a crimp band, wherein:
the one or more strength members are disposed about the front portion of the retention body and routed toward the rear portion of the retention body; and
the crimp band is crimped to a crimp region of the front portion of the retention body such that the one or more strength members are positioned between the front portion of the retention body and the crimp band.

6. The fiber optic connector assembly of claim 4, wherein:
the housing further comprises an adhesive aperture;
the front portion of the retention body further comprises an annular wicking region and an annular adhesive reservoir;
the adhesive aperture of the housing is aligned with the annular adhesive reservoir of the retention body; and
an adhesive is disposed within the adhesive aperture, the annular adhesive reservoir and the annular wicking region to secure the retention body to the housing.

7. The fiber optic connector assembly of claim 4, wherein:
the rear portion of the retention body comprises an engagement groove;
the fiber optic connector assembly further comprises a heat shrink member disposed over the optical cable and a portion of the rear portion of the retention body;
the boot comprises a barb at an interior surface of the insertion end; and
the barb is positioned within the engagement groove to secure the boot to the retention body.

8. The fiber optic connector assembly of claim 1, further comprising a primary sealing member disposed within the primary groove and a secondary sealing member disposed within the secondary groove.

9. The fiber optic connector assembly of claim 8, wherein the primary sealing member is an O-ring and the secondary sealing member is a tapered sealing member.

10. The fiber optic connector assembly of claim 8, wherein the secondary sealing member comprises a straight portion and a tapered portion extending from an end of the straight portion.

11. The fiber optic connector assembly of claim 4, wherein the one or more strength members comprises aramid fiber.

12. A fiber optic connector assembly comprising:
a housing comprising a rear end and a front end with a longitudinal passageway extending from the rear end to the front end, wherein the rear end comprises a flange;
a retention body comprising a first end, a reduced diameter portion at the first end, a rear wall, and a second end extending from the rear wall, wherein:
a diameter of a central portion is greater than a diameter of a front portion and a rear portion such that the central portion defines a front wall and rear wall, and
the front portion of the retention body is disposed within the longitudinal passageway of the housing such that the front wall and the flange define a primary groove, and
the second end of the retention body comprises an engagement groove; and
a boot having an insertion end and a barb at an interior surface of the insertion end, wherein the boot is disposed over a portion of the rear end of the retention body such that the insertion end of the boot and the rear wall of the retention body define a secondary groove and the barb is disposed within the engagement groove.

13. The fiber optic connector assembly of claim 12, wherein the retention body is fabricated from a metal.

14. The fiber optic connector assembly of claim 12, further comprising a ferrule assembly comprising a ferrule holder, a ferrule disposed in the ferrule holder, and a ferrule spring, wherein the ferrule assembly is disposed within the longitudinal passageway at the front end of the housing.

15. The fiber optic connector assembly of claim 12, further comprising an optical cable comprising a jacket, one or more strength members within the jacket, and an optical fiber within the jacket.

16. The fiber optic connector assembly of claim 15, further comprising a crimp band, wherein:
the one or more strength members are disposed on the front portion of the retention body in a direction toward the rear portion of the retention body; and
the crimp band is crimped to a crimp region of the front portion of the retention body such that the one or more strength members are positioned between the front portion of the retention body and the crimp band.

17. The fiber optic connector assembly of claim 16, wherein:
the housing further comprises an adhesive aperture;
the front portion of the retention body further comprises an annular wicking region and an annular adhesive reservoir;
the adhesive aperture of the housing is aligned with the annular adhesive reservoir of the retention body; and
an adhesive is disposed within the adhesive aperture, the annular adhesive reservoir and the annular wicking region to secure the retention body to the housing.

18. The fiber optic connector assembly of claim 15, wherein the fiber optic connector assembly further comprises a heat shrink member disposed over the optical cable and a portion of the second end of the retention body up to the engagement groove.

19. The fiber optic connector assembly of claim 12, further comprising a primary sealing member disposed within the primary groove and a secondary sealing member disposed within the secondary groove.

20. The fiber optic connector assembly of claim 19, wherein the primary sealing member is an O-ring and the secondary sealing member is a tapered sealing member.

21. The fiber optic connector assembly of claim 19, wherein the secondary sealing member comprises a straight portion and a tapered portion extending from an end of the straight portion.

22. The fiber optic connector assembly of claim 15, wherein the one or more strength members comprises Kevlar.

23. A method of assembling a fiber optic connector assembly, the method comprising:
removing a portion of a jacket of an optical cable to expose one or more strength members and an optical fiber;
cutting the one or more strength members;
inserting the optical cable into a retention body;
wrapping the one or more strength members around a front portion of the retention body in a direction toward a rear portion of the retention body such that the one or more strength members are disposed within a strength member enclosure of the cable adapter, and the optical fiber extends through an opening of a front end of the cable adapter;
crimping a crimp band on a crimp region of the front portion of the retention body such that the one or more strength members are positioned between the crimp region of the retention body and the crimp band;
inserting the front portion of the retention body into a longitudinal passageway of a housing such that the front portion is disposed within a rear end of the housing and an end of the optical fiber is positioned within a ferrule assembly disposed within a front end of the housing, wherein:
the retention body and the flange define a primary groove;
the housing comprises a flange at the rear end and an adhesive aperture;
the front end of the retention body further comprises an annular wicking region and an annular adhesive reservoir; and
the adhesive aperture of the housing is aligned with the annular adhesive reservoir of the retention body; and
disposing an adhesive within the adhesive aperture, the annular adhesive reservoir and the annular wicking region;
applying a curing energy to at least one of the retention body and the housing to cure the adhesive; and
securing an insertion end of a boot to a portion of the second end of the connector sleeve, wherein the optical cable is disposed through the boot, and the boot and the retention body define a secondary groove.

24. The method of claim 23, wherein:
the rear portion of the retention body comprises an engagement groove;
the boot comprises a barb at an interior surface of the insertion end; and
securing the insertion end of the boot to the rear portion of the retention body comprises positioning the boot over the rear portion of the retention body such that the barb is disposed within the engagement groove.

25. The method of claim 23, further comprising, prior to securing the insertion end of the boot to the rear end of the retention body, applying a heat shrink member over a portion of the optical cable and at least part of the rear portion of the retention body.

26. The method of claim 23, further comprising positioning a primary sealing member within the primary groove and positioning a secondary sealing member within the secondary groove.
